(19) United States
(12) Patent Application Publication
(10) Pub. No.: US 2026/0155535 A1
(43) Pub. Date: Jun. 4, 2026

(54) BATTERY ASSEMBLY

(71) Applicant: SK On Co., Ltd., Seoul (KR)

(72) Inventors: Bon Seok KU, Daejeon (KR); Hae Ryong JEON, Daejeon (KR)

(21) Appl. No.: 19/403,192

(22) Filed: Nov. 27, 2025

(30) Foreign Application Priority Data
Dec. 3, 2024 (KR) 10-2024-0177484

(51) Int. Cl. H01M 50/507; H01M 50/55; H01M 50/588

(52) U.S. Cl. CPC H01M 50/507; H01M 50/55; H01M 50/588

(57) ABSTRACT

The present disclosure relates to a battery assembly comprising: a plurality of battery groups including battery cells; a receiving case configured to accommodate the plurality of battery groups; a support portion disposed inside the receiving case with any one of the plurality of battery groups interposed therebetween; and a busbar portion supported by the support portion inside the receiving case and configured to electrically connect battery cells of the any one of the battery groups or electrically connect between the plurality of battery groups.

### CROSS-REFERENCE TO RELATED PATENT APPLICATION

The present application claims priority under 35 U.S.C. § 119(a) to Korean patent application number 10-2024-0177484 filed on December 3, 2024, in the Korean Intellectual Property Office, the entire disclosure of which is incorporated by reference herein.

### BACKGROUND OF THE INVENTION

### 1. Field

The present disclosure relates to a battery assembly.

### 2. Description of the Related Art

A conventional battery assembly including prismatic battery cells fixes the prismatic battery cells to a bottom surface of a receiving case using only a thermal adhesive. In addition, the busbar merely serves to electrically connect the prismatic battery cells and does not perform any other function. Such a structure, having no physical or mechanical coupling structure between the prismatic battery cells and the receiving case, may be affected by strong external vibrations or impacts.

Accordingly, it is necessary to prevent the position of the prismatic battery cells from being displaced by strong external vibrations or impacts, or the busbar from being deformed, which could affect the electrical connection.

### SUMMARY OF THE INVENTION

According to one aspect of the present disclosure, the problem to be solved is to improve the structural stability of a battery assembly.

According to another aspect of the present disclosure, the problem to be solved is to enhance the lifespan of the battery assembly.

According to still another aspect of the present disclosure, the problem to be solved is to maintain the position of the battery cells without change even under strong external impacts or vibrations.

According to yet another aspect of the present disclosure, the problem to be solved is to allow the busbar to perform not only an electrical connection function but also a mechanical connection function simultaneously.

Meanwhile, the present disclosure can be widely applied to green technology fields such as electric vehicles (EVs), battery charging stations, and energy storage systems (ESS), as well as photovoltaic power generation and wind power generation using batteries. In addition, the present disclosure can be used for eco-friendly mobility, including electric vehicles and hybrid vehicles, to suppress air pollution and greenhouse gas emissions and to prevent climate change.

As a technical means to achieve the technical objects, a battery assembly according to the present disclosure may include: a plurality of battery groups including battery cells; a receiving case configured to accommodate the plurality of battery groups; a support portion disposed inside the receiving case with any one of the plurality of battery groups interposed therebetween; and a busbar portion supported by the support portion inside the receiving case and configured to electrically connect battery cells of the any one of the battery groups or electrically connect between the plurality of battery groups.

In one embodiment, the support portion may include a partition support portion positioned between the any one of the battery groups and another one of the battery groups that is adjacent to the any one of the battery groups, and the busbar portion may include a first busbar supported by the partition support portion and configured to electrically connect the battery cells of the any one of the battery groups.

In one embodiment, the any one of the battery groups may include a first battery cell and a second battery cell arranged in a stacking direction, each of the first battery cell and the second battery cell may include a first terminal portion and a second terminal portion protruding for electrical connection, and the first terminal portion and the second terminal portion of the first battery cell may be respectively disposed to overlap with the second terminal portion and the first terminal portion of the second battery cell along the stacking direction.

In one embodiment, the first busbar may include a first part configured to electrically connect the first terminal portion of the first battery cell and the second terminal portion of the second battery cell, and a second part extending from the first part toward the partition support portion and coupled to the partition support portion.

In one embodiment, the first part and the second part may be integrally formed.

In one embodiment, the second part may be coupled to the partition support portion by a fastening member.

In one embodiment, at least a portion of the fastening member may be coated with an electrically insulating material.

In one embodiment, the battery assembly according to the present disclosure may further include an insulating member disposed between the partition support portion and the second part.

In one embodiment, in another one of the battery groups disposed adjacent to the any one of the battery groups with the partition support portion interposed therebetween, the respective second parts of the any one of the battery group and the another one of the battery groups may be alternately arranged along the stacking direction on the partition support portion.

Meanwhile, in one embodiment, the first busbar may include extension members respectively extending from the first terminal portion of the first battery cell and the second terminal portion of the second battery cell toward the partition support portion and supported by the partition support portion, and a connection member supported by the partition support portion and configured to electrically connect the extension members to each other.

In one embodiment, the connection member may be disposed between the extension members and the partition support portion.

In one embodiment, the extension members and the connection member may be coupled to the partition support portion by a fastening member.

In one embodiment, at least a portion of the fastening member may be coated with an electrically insulating material.

In one embodiment, the battery assembly according to the present disclosure may further include an insulating member disposed on the partition support portion and configured to electrically insulate the first busbar from the partition support portion.

In one embodiment, the busbar portion may further include a second busbar supported by the partition support portion and configured to electrically connect between the plurality of battery groups.

In one embodiment, based on a bottom surface of the receiving case, a height of the partition support portion may be lower than a height of the battery cell of the any one of the battery groups.

In one embodiment, the support portion may include a partition support portion positioned between the any one of the battery groups and another one of the battery groups that is adjacent to the any one of the battery groups, and a side support portion disposed between one side surface of both side surfaces of the receiving case and the plurality of battery groups to face the partition support portion.

According to one embodiment of the present disclosure, the structural stability of the battery assembly can be improved.

According to another embodiment of the present disclosure, the lifespan of the battery assembly can be enhanced.

According to still another embodiment of the present disclosure, the position of the battery cells can be maintained without change even under strong external impacts or vibrations.

According to yet another embodiment of the present disclosure, the busbar can perform not only an electrical connection function but also a mechanical connection function simultaneously.

### BRIEF DESCRIPTION OF THE DRAWINGS

FIG. 1 is an example of a battery assembly according to the present disclosure.

FIG. 2 is an example of a battery cell.

FIG. 3 is another example of a battery assembly according to the present disclosure.

FIG. 4 is an example of a first busbar portion according to the present disclosure.

FIG. 5 schematically illustrates an electrical connection state and a mechanical connection state of the first busbar portion of FIG. 4.

FIG. 6 shows a cross-sectional view of the first busbar portion and the partition support portion of FIG. 4.

FIG. 7 is another example of a first busbar portion according to the present disclosure.

FIG. 8 schematically illustrates an electrical connection state and a mechanical connection state of the first busbar portion of FIG. 7.

FIG. 9 shows a cross-sectional view of the first busbar portion and the partition support portion of FIG. 7.

### DETAILED DESCRIPTION

Hereinafter, preferred embodiments of the present disclosure will be described in detail with reference to the accompanying drawings. The configuration or control method of the device described below is merely for illustrating embodiments of the present disclosure and is not intended to limit the scope of the present disclosure, and reference numerals used consistently throughout the specification denote identical components.

Specific terms used in the present specification are merely for convenience of explanation and are not intended to limit the illustrated embodiments.

In the present specification, the terms “battery,” “secondary battery,” and “cell” all refer to a battery cell capable of charge and discharge.

In the present specification, the term “battery assembly” may refer to a battery module including battery cells, a battery pack, or an energy storage system (ESS).

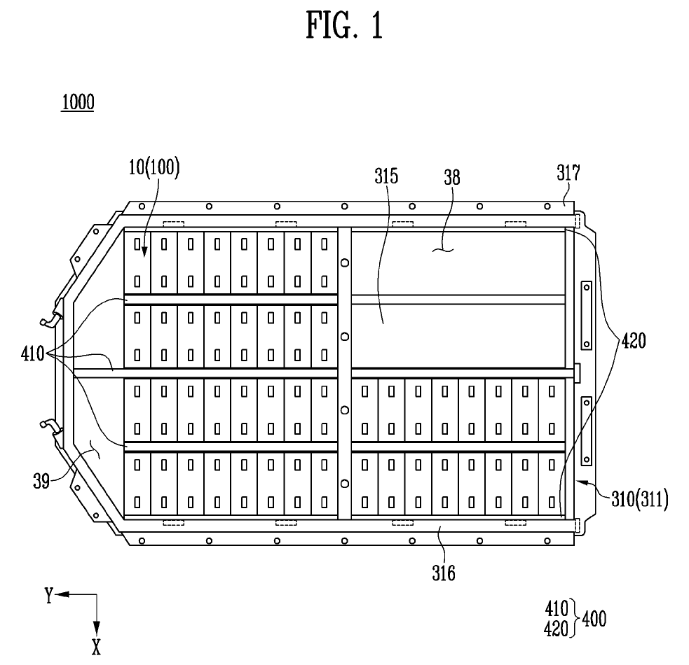

FIG. 1 is an example of a battery assembly according to the present disclosure.

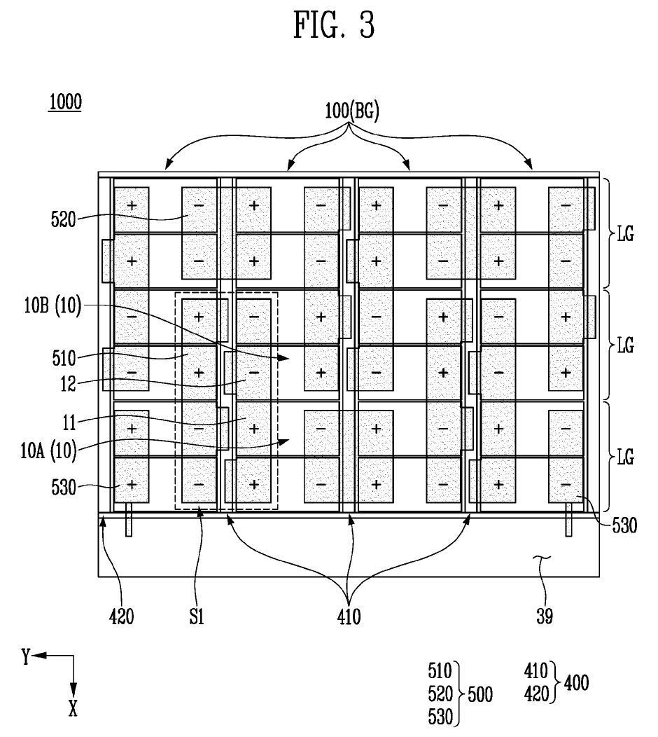

The battery assembly 1000 according to the present disclosure may include a plurality of battery groups 100 including battery cells 10, a receiving case 310 configured to accommodate the plurality of battery groups 100, a support portion 400 disposed inside the receiving case 310 with any one of the plurality of battery groups 100 interposed therebetween, and a busbar portion 500, see FIG. 3, supported by the support portion 400 inside the receiving case 310 and configured to electrically connect the battery cells 10 of the any one of the battery groups 100 or electrically connect between the plurality of battery groups 100.

The receiving case 310 may form a receiving space 38 for accommodating the plurality of battery groups 100. More specifically, the receiving case 310 may include a receiving body 311 having an opening on one surface and forming the receiving space 38 for accommodating the plurality of battery groups 100 through the opening, and a receiving cover (not shown) coupled to the receiving body 311 to cover the opening.

The receiving case 310 may include a bottom surface 315 of the receiving case that forms a bottom surface of the receiving space 38 or a bottom surface of the receiving body 311. In addition, the receiving case 310 may further include receiving body side surfaces 316 and 317 that form one side surface of the receiving space 38 or one side surface of the receiving body 311.

The receiving case 310 may further include an electrical compartment 39 separated from the receiving space 38. The electrical compartment 39 may accommodate a control unit (not shown) for controlling the plurality of battery cells. The control unit may be referred to as a BMS (Battery Management System).

The receiving space 38 may accommodate the plurality of battery groups 100. Each of the plurality of battery groups 100 may include battery cells 10. Therefore, the receiving space 38 may include a plurality of battery cells 10.

Preferably, each of the plurality of battery groups 100 may include a plurality of battery cells 10 stacked along a predetermined stacking direction (for example, the Y-direction).

FIG. 1 illustrates an example in which the plurality of battery groups 100 are arranged in four columns along the X-direction and two rows along the Y-direction. However, this is merely an example, and the number of rows and columns of the plurality of battery groups 100 may vary depending on design.

The support portion 400 may include a partition support portion 410 positioned between the any one of the battery groups 100 and another one of the battery groups 100 that is adjacent to the any one of the battery groups 100, and a side support portion 420 disposed between one side surface of both side surfaces of the receiving case 310 and the plurality of battery groups to face the partition support portion 410.

That is, when any one of the battery groups 100 is disposed adjacent to one side surface of both side surfaces of the receiving case 310, the any one of the battery groups 100 may be disposed between the partition support portion 410 and the side support portion 420.

Conversely, when any one of the battery groups 100 is not disposed adjacent to one side surface of the receiving case 310 but disposed between other adjacent battery groups 100, the any one of the battery groups 100 may be positioned between a pair of partition support portions 410 disposed with the any one of the battery groups 100 interposed therebetween.

Both side surfaces of the receiving case 310 may be the receiving body side surfaces 316 and 317. FIG. 1 shows that both side surfaces of the receiving case 310 may be side surfaces parallel to the stacking direction.

The partition support portion 410 may partition the plurality of battery groups 100 inside the receiving case 310. Accordingly, the partition support portion 410 may be disposed between the plurality of battery groups 100.

Conversely, the side support portion 420 may be formed by a portion of the receiving body side surfaces 316 and 317 protruding toward the plurality of battery groups 100, or may be formed to protrude from the bottom surface 315 of the receiving case.

That is, the side support portion 420 may be disposed between the receiving body side surfaces 316 and 317 and the plurality of battery groups 100.

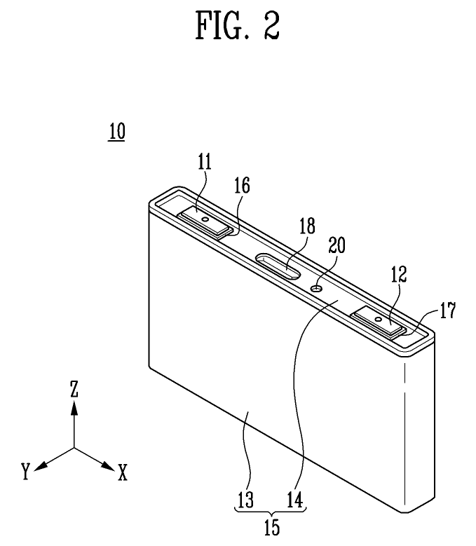

FIG. 2 is an example of a battery cell.

More specifically, FIG. 2 illustrates an example of a battery cell 10 accommodated in the receiving case 310. Preferably, the battery cell 10 may be a prismatic battery cell.

The battery cell 10 may include a cell case 15 accommodating an electrode assembly (not shown) therein, and terminal portions 11 and 12 connected to the electrode assembly and protruding outward from the cell case 15.

The cell case 15 may have a rectangular parallelepiped shape. The cell case 15 may include a cell body 13 having an inlet on one surface and accommodating the electrode assembly through the inlet, and a cap assembly 14 coupled to the cell body 13 to cover the inlet.

The terminal portions 11 and 12 may include a first terminal portion 11 and a second terminal portion 12 protruding outward through the cap assembly 14.

When the first terminal portion 11 has one of a positive or a negative polarity, the second terminal portion 12 may have the other polarity between the positive and the negative. That is, the first terminal portion 11 and the second terminal portion 12 may have different electrical polarities.

The battery cell 10 may further include a first gasket 16 disposed between the first terminal portion 11 and the cap assembly 14, and a second gasket 17 disposed between the second terminal portion 12 and the cap assembly 14, for sealing and electrical insulation between the first terminal portion 11 and the cap assembly 14 and between the second terminal portion 12 and the cap assembly 14.

In addition, the battery cell 10 may further include an injection hole 20 formed through the cap assembly 14 to inject an electrolyte into the inside of the cell case 15, and a vent hole 18 configured to rupture when an internal pressure of the cell case 15 exceeds a predetermined pressure.

FIG. 3 is another example of a battery assembly according to the present disclosure.

More specifically, FIG. 3 illustrates a schematic layout of the busbar portion 500.

As described above, the battery assembly 1000 according to the present disclosure may include a plurality of battery groups 100 including battery cells 10, a receiving case 310 configured to accommodate the plurality of battery groups 100, a support portion 400 disposed inside the receiving case 310 with any one of the plurality of battery groups 100 interposed therebetween, and a busbar portion 500 supported by the support portion 400 inside the receiving case 310 and configured to electrically connect the battery cells 10 of the any one of the battery groups 100 or electrically connect between the plurality of battery groups 100.

The busbar portion 500 may connect the plurality of battery cells 10 in series or in parallel so that the battery assembly 1000 can be charged and discharged at a predetermined voltage.

Specifically, the busbar portion 500 may include a first busbar 510 supported by the partition support portion 410 or the side support portion 420 and configured to electrically connect the battery cells 10 of the any one of the battery groups 100.

This applies when the any one of the battery groups 100 is positioned adjacent to one side surface of the receiving case 310.

Conversely, the busbar portion 500 may include a first busbar 510 supported by the partition support portion 410 and configured to electrically connect the battery cells 10 of the any one of the battery groups 100.

This applies when the any one of the battery groups 100 is positioned between a pair of adjacent other battery groups 100.

That is, the support portion 400 may include a partition support portion 410 positioned between the any one of the battery groups 100 and another one of the battery groups 100 that is adjacent to the any one of the battery groups 100, and the busbar portion 500 may include a first busbar 510 supported by the partition support portion 410 and configured to electrically connect the battery cells 10 of the any one of the battery groups 100.

The plurality of battery cells 10 included in the any one of the battery groups 100 may be connected in series or in parallel by the first busbar 510.

Among the plurality of battery cells 10 included in the any one of the battery groups 100, the battery cells 10 connected with the same polarity may be referred to as a logical group LG. That is, the logical group LG may be connected in parallel by the first busbar 510.

The any one of the battery groups 100 may include one or more logical groups LG, and the one or more logical groups LG may be connected with different polarities. That is, the any one of the battery groups 100 may include one or more logical groups LG connected in series with each other.

For example, a first battery cell 10A and a second battery cell 10B of the any one of the battery groups 100 may belong to different logical groups LG.

Since the different logical groups LG are connected in series with each other, the any one of the battery groups 100 may include the first battery cell 10A and the second battery cell 10B arranged in a predetermined stacking direction, the first battery cell 10A and the second battery cell 10B may each include a first terminal portion 11 and a second terminal portion 12 protruding for electrical connection, and the first terminal portion 11 and the second terminal portion 12 of the first battery cell 10A may be respectively disposed to overlap with the second terminal portion 12 and the first terminal portion 11 of the second battery cell 10B along the stacking direction.

In addition, the arrangement of the respective first terminal portions 11 and the respective second terminal portions 12 of the first battery cell 10A and the second battery cell 10B of the any one of the battery groups 100 may be the same as the arrangement of the respective first terminal portions 11 and the respective second terminal portions 12 of the first battery cell 10A and the second battery cell 10B of another one of the battery groups 100. Through this, the battery cells 10 belonging to different battery groups 100 may face terminal portions having opposite polarities. This is to simplify the connection path of the first busbar.

The busbar portion 500 may further include a second busbar 520 supported by the partition support portion 410 and configured to electrically connect between the plurality of battery groups 100.

The second busbar 520 may connect the any one of the battery groups 100 and another one of the battery groups 100 adjacent thereto in series.

The busbar portion 500 may further include a connection busbar 530 configured to electrically connect the plurality of battery groups 100 to an external circuit.

The connection busbar 530 may be disposed on the battery groups 100 located at both electrical ends among the plurality of battery groups 100 after the plurality of battery groups 100 are electrically connected.

The support portion 400 may include a partition support portion 410 positioned between the plurality of battery groups 100, and a side support portion 420 extending in parallel with the partition support portion 410 and positioned on the receiving body side surfaces 316 and 317, or between the receiving body side surfaces 316 and 317 and the plurality of battery groups 100.

The first busbar 510 may be supported by the partition support portion 410 or the side support portion 420.

The second busbar 520 may be supported by the partition support portion 410, and the connection busbar 530 may protrude toward the outside or toward the electrical compartment 39 without separate support.

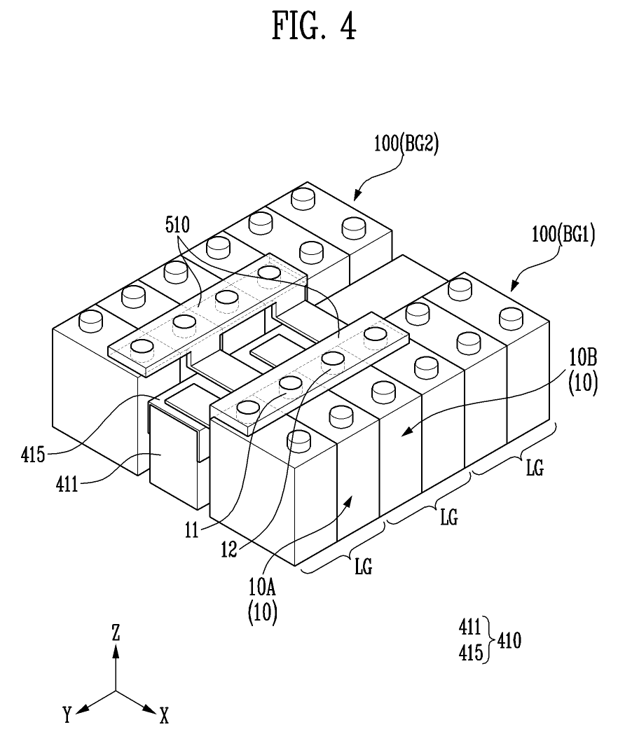

FIG. 4 is an example of a first busbar portion according to the present disclosure.

Specifically, FIG. 4 illustrates the S1 portion of FIG. 3.

The partition support portion 410 may be positioned between any one of the battery groups 100 (or a first battery group BG1) and another one of the battery groups 100 (or a second battery group BG2).

The partition support portion 410 may be supported by the bottom surface 315 of the receiving case and may be formed to protrude from the bottom surface 315 of the receiving case (see FIG. 1).

A portion of the first busbar 510 may be supported by the partition support portion 410, and another portion of the first busbar 510 may electrically connect the battery cells 10 included in the first battery group BG1.

Similarly, a portion of the first busbar 510 may be supported by the partition support portion 410, and another portion of the first busbar 510 may electrically connect the battery cells 10 included in the second battery group BG2.

When the first battery group BG1 is positioned between the side support portion 420 and the partition support portion 410, a portion of the first busbar 510 may be supported by the partition support portion 410, and another portion thereof may electrically connect the battery cells 10 included in the first battery group BG1.

Referring to FIG. 4, the first battery group BG1 may include a first battery cell 10A and a second battery cell 10B stacked in the stacking direction, and the first battery cell 10A and the second battery cell 10B may belong to different logical groups LG.

The first busbar 510 may extend along the stacking direction to electrically connect the first terminal portion 11 of the first battery cell 10A and the second terminal portion 12 of the second battery cell 10B, and may extend toward the partition support portion 410 to be supported by the partition support portion 410.

Similarly, the second battery group BG2 may include a first battery cell 10A, a second battery cell 10B, and the first busbar 510, which are stacked in the stacking direction. The first busbar 510 may extend along the stacking direction to electrically connect the first terminal portion 11 of the first battery cell 10A and the second terminal portion 12 of the second battery cell 10B, and may extend toward the partition support portion 410 to be supported by the partition support portion 410.

The partition support portion 410 may include a support body 411 protruding from the bottom surface 315 of the receiving case, and an insulating member 415 covering at least a portion of an outer surface of the support body 411.

More specifically, the insulating member 415 may cover an upper surface of the support body 411, and may be bent from both edges of the upper surface of the support body 411 toward the bottom surface 315 of the receiving case to cover a portion of side surfaces of the support body 411.

Accordingly, one cross-sectional shape of the insulating member 415 may have an inverted U-shape. That is, the insulating member 415 may have a channel shape extending parallel to and facing the support body 411. Alternatively, the insulating member 415 may extend parallel to the support body 411 and may have a recessed shape allowing at least a portion of the support body 411 to be inserted therein.

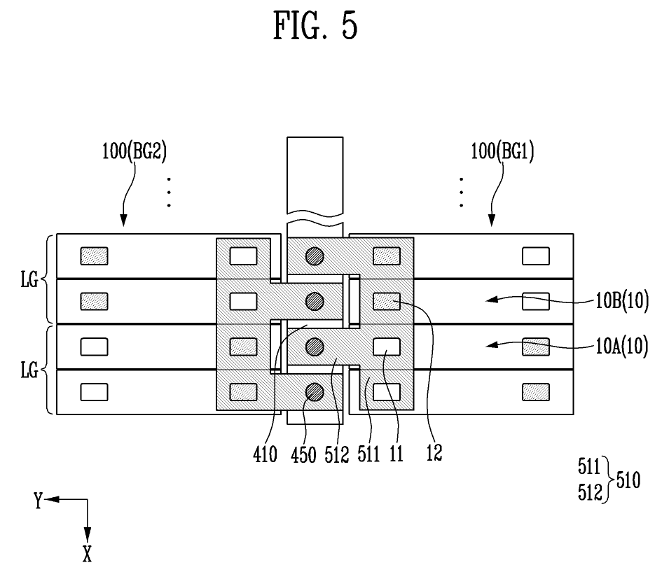

FIG. 5 schematically illustrates an electrical connection state and a mechanical connection state of the first busbar portion of FIG. 4.

The first busbar 510 may include a first part 511 configured to electrically connect the first terminal portion 11 of the first battery cell 10A and the second terminal portion 12 of the second battery cell 10B, and a second part 512 extending from the first part 511 toward the partition support portion 410 and coupled to the partition support portion 410.

If the first part 511 performs an electrical connection function of the first busbar 510, the second part 512 may perform a mechanical connection function of the first busbar 510. Therefore, since the battery cells 10 are supported by the partition support portion 410 through the second part 512, the effects of external impacts and vibrations on the battery cells 10 can be minimized.

The first part 511 may extend along the stacking direction. The length of the first part 511 may vary depending on the number of battery cells 10 included in adjacent logical groups LG (see FIG. 4) that are connected by the first part 511.

For example, FIG. 5 illustrates an example in which one logical group LG includes two battery cells 10. Therefore, the first part 511 may electrically connect the first terminal portions 11 of two battery cells 10 and the second terminal portions 12 of two battery cells 10. The second part 512 may extend toward the partition support portion 410.

The second part 512 may be provided in a plurality. As the length of the first part 511 extending along the stacking direction increases, the number of the second parts 512 may increase. This is to more stably support the first part 511.

In addition, a protruding length of the second part 512 from the first part 511 may be longer than a distance from the first part 511 to a fastening member 450 described later.

Accordingly, it is necessary to prevent interference between the second part 512 included in the any one of the battery groups 100 and the second part 512 included in another one of the battery groups 100 disposed with the partition support portion 410 interposed therebetween.

To this end, in the any one of the battery group 100 (or the first battery group BG1) and another one of the battery groups 100 (or the second battery group BG2) disposed adjacent to each other with the partition support portion 410 interposed therebetween, the respective second parts 512 of the any one of the battery group 100 and the another one of the battery groups 100 may be alternately arranged along the stacking direction on the partition support portion 410.

Furthermore, the first part 511 and the second part 512 may be integrally formed. Therefore, since the first busbar 510 is a single component, the manufacturing speed of the battery assembly 1000 can be improved.

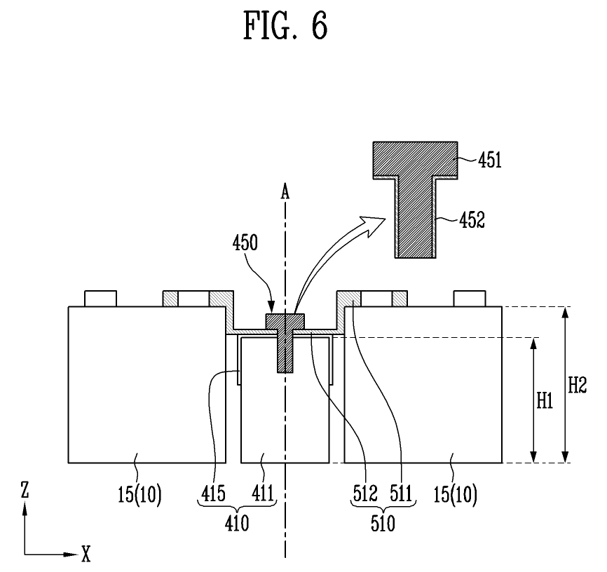

FIG. 6 shows a cross-sectional view of the first busbar portion and the partition support portion of FIG. 4.

The second part 512 may be coupled to the partition support portion 410 by a fastening member 450.

As described above, the protruding length of the second part 512 from the first part 511 may be longer than the distance from the first part 511 to the fastening member 450 described later. Therefore, the fastening member 450 may be positioned in a central region A of the partition support portion 410.

At least a portion of the fastening member 450 may be coated with an electrically insulating material. That is, the partition support portion 410 may be formed of a metal material in consideration of strength. Accordingly, the fastening member 450 may include a fastening body 451 forming an external shape and a coating layer 452 coating the fastening body 451 with an electrically insulating material.

In addition, the battery assembly 1000 according to the present disclosure may further include an insulating member 415 disposed between the partition support portion 410 and the second part 512.

Meanwhile, based on the bottom surface 315 of the receiving case, a height of the partition support portion 410 may be lower than a height of the battery cell 10 of the any one of the battery groups 100. This is to prevent unnecessary space from being wasted due to the partition support portion 410.

Accordingly, while the first part 511 may have a planar shape, the second part 512 may have a bent shape.

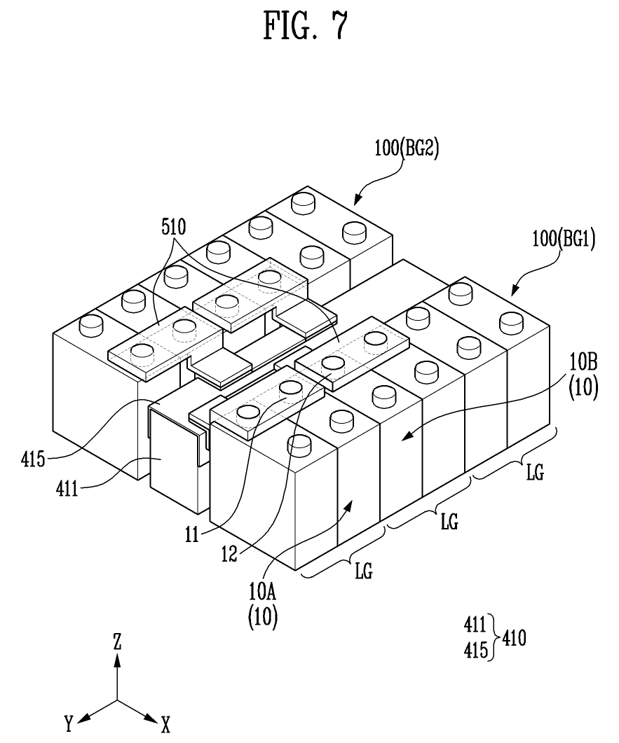

FIG. 7 is another example of a first busbar portion according to the present disclosure.

Specifically, FIG. 7 illustrates the S1 portion of FIG. 3.

The partition support portion 410 may be positioned between any one of the battery groups 100 (or a first battery group BG1) and another one of the battery groups 100 (or a second battery group BG2).

The partition support portion 410 may be supported by the bottom surface 315 of the receiving case and may be formed to protrude from the bottom surface 315 of the receiving case (see FIG. 1).

A portion of the first busbar 510 may be supported by the partition support portion 410, and another portion of the first busbar 510 may electrically connect the battery cells 10 included in the first battery group BG1.

Similarly, a portion of the first busbar 510 may be supported by the partition support portion 410, and another portion of the first busbar 510 may electrically connect the battery cells 10 included in the second battery group BG2.

When the first battery group BG1 is positioned between the side support portion 420 and the partition support portion 410, a portion of the first busbar 510 may be supported by the partition support portion 410, and another portion thereof may electrically connect the battery cells 10 included in the first battery group BG1.

Referring to FIG. 7, the first battery group BG1 may include a first battery cell 10A and a second battery cell 10B stacked in the stacking direction, and the first battery cell 10A and the second battery cell 10B may belong to different logical groups LG.

The first busbar 510 may respectively extend from the first terminal portion 11 of the first battery cell 10A and the second terminal portion 12 of the second battery cell 10B toward the partition support portion 410 so that a portion thereof is supported by the partition support portion 410. In addition, the first busbar 510 may extend along the stacking direction on the partition support portion 410 to electrically connect the first terminal portion 11 of the first battery cell 10A and the second terminal portion 12 of the second battery cell 10B.

Similarly, the second battery group BG2 may include a first battery cell 10A, a second battery cell 10B, and the first busbar 510 stacked in the stacking direction. The first busbar 510 may respectively extend from the first terminal portion 11 of the first battery cell 10A and the second terminal portion 12 of the second battery cell 10B toward the partition support portion 410 so that a portion thereof is supported by the partition support portion 410. In addition, the first busbar 510 may extend along the stacking direction on the partition support portion 410 to electrically connect the first terminal portion 11 of the first battery cell 10A and the second terminal portion 12 of the second battery cell 10B.

The partition support portion 410 may include a support body 411 protruding from the bottom surface 315 of the receiving case, and an insulating member 415 covering at least a portion of an outer surface of the support body 411.

More specifically, the insulating member 415 may cover an upper surface of the support body 411, and may be bent from both edges of the upper surface of the support body 411 toward the bottom surface 315 of the receiving case to cover a portion of side surfaces of the support body 411.

Accordingly, a cross section of the insulating member 415 may have an inverted U-shape. That is, the insulating member 415 may have a channel shape extending parallel to and facing the support body 411. Alternatively, the insulating member 415 may extend parallel to the support body 411 and have a recessed shape in which at least a portion of the support body 411 is inserted.

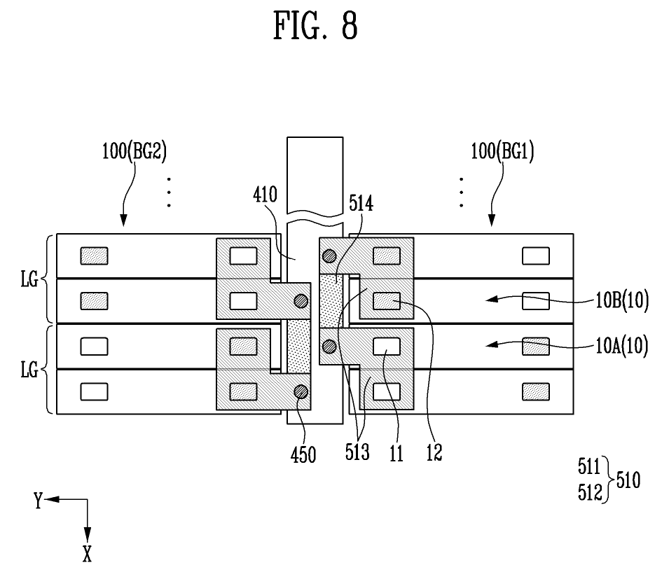

FIG. 8 schematically illustrates an electrical connection state and a mechanical connection state of the first busbar portion of FIG. 7.

The first busbar 510 may include extension members 513 respectively extending from the first terminal portion 11 of the first battery cell 10A and the second terminal portion 12 of the second battery cell 10B toward the partition support portion 410 and supported by the partition support portion 410, and a connection member 514 supported by the partition support portion 410 and configured to electrically connect the extension members 513 to each other.

The extension members 513 may perform a mechanical connection function of the first busbar 510, and at the same time, may perform an electrical connection function together with the connection member 514 by being connected thereto. That is, since the battery cells 10 are supported by the partition support portion 410 through the extension members 513, the battery cells 10 can minimize the effects of external impacts and vibrations.

The connection member 514 may extend along the stacking direction.

The extension members 513 may have a straight or L-shaped form. The length and shape of the extension members 513 along the stacking direction may vary depending on the number of battery cells 10 included in any one logical group LG connected by the extension members 513.

When only one battery cell 10 is included in any one logical group LG, the extension members 513 may have a straight shape. In contrast, when a plurality of battery cells 10 are included in any one logical group LG, the extension members 513 may have an L-shaped form. As the number of battery cells 10 included in any one logical group LG increases, a length of a portion of the extension members 513 that connects the terminal portions belonging to the same logical group LG may increase.

For example, FIG. 8 illustrates an example in which one logical group LG includes two battery cells 10. Accordingly, the extension members 513 may each electrically connect the first terminal portions 11 of two battery cells 10 and the second terminal portions 12 of two battery cells 10. The connection member 514 may be disposed on the partition support portion 410 to electrically connect the extension members 513.

The connection member 514 may be disposed between the extension members 513 and the partition support portion 410, and a portion of the connection member 514 may be arranged to overlap with a portion of the extension members 513.

In addition, it is necessary to prevent interference between the connection member 514 included in any one of the battery groups 100 and the connection member 514 included in another one of the battery groups 100 disposed with the partition support portion 410 interposed therebetween.

The respective connection members 514 of the any one of the battery group 100 and the another one of the battery groups 100 may be arranged to partially overlap along the stacking direction on the partition support portion 410.

Therefore, the respective connection members 514 of the any one of the battery group 100 and the another one of the battery groups 100 may be spaced apart from each other to avoid interference.

To achieve this, in a width direction from the any one of the battery group 100 toward the another one of the battery groups 100, a sum of the widths of the connection members 514 of the any one of the battery group 100 and the another one of the battery groups 100 may be smaller than the width of the partition support portion 410.

That is, a length of overlap between the extension members 513 and the partition support portion 410 along the width direction may be less than half of the width of the partition support portion 410.

Furthermore, in the any one of the battery group 100 and the another one of the battery groups 100 disposed adjacent to each other with the partition support portion 410 interposed therebetween, the respective extension members 513 of the any one of the battery group 100 and the another one of the battery groups 100 may be alternately arranged along the stacking direction on the partition support portion 410.

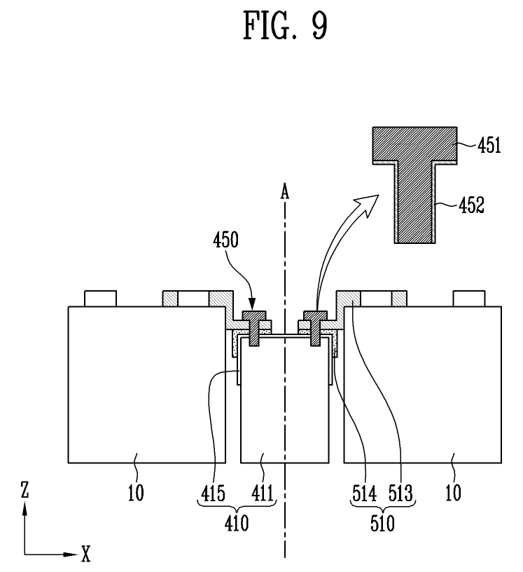

FIG. 9 shows a cross-sectional view of the first busbar portion and the partition support portion of FIG. 7.

The extension members 513 and the connection member 514 may be coupled to the partition support portion 410 by a fastening member 450.

Specifically, in one embodiment, the connection member 514 may be disposed between the extension members 513 and the partition support portion 410. Each of the extension members 513 may be arranged to overlap with the connection member 514 and the partition support portion 410, and thus the fastening member 450 may penetrate through the overlapped portions of the extension members 513 and the partition support portion 410 to be coupled to the partition support portion 410.

As described above, a length of overlap between the extension members 513 and the partition support portion 410 along the width direction may be less than half of the width of the partition support portion 410. Therefore, the fastening member 450 may be positioned off the central region A of the partition support portion 410.

In one embodiment, at least a portion of the fastening member 450 may be coated with an electrically insulating material. That is, the partition support portion 410 may be formed of a metal material in consideration of strength. Accordingly, the fastening member 450 may include a fastening body 451 forming an external shape, and a coating layer 452 coating the fastening body 451 with an electrically insulating material.

In addition, the battery assembly 1000 according to the present disclosure may further include an insulating member 415 disposed on the partition support portion 410 and configured to electrically insulate the first busbar 510 from the partition support portion 410.

Meanwhile, based on the bottom surface of the receiving case, a height of the partition support portion 410 may be lower than a height of the battery cell 10 of any one of the battery groups 100. This is to prevent unnecessary space from being wasted due to the partition support portion 410.

Accordingly, the extension members 513 may have a bent shape, while the connection member 514 may have a planar shape.

Alternatively, based on the bottom surface of the receiving case, a height of the partition support portion 410 may be lower than a height of the cell case 15 of any one of the battery groups 100.

The present disclosure may be implemented in various forms and is not limited to the above-described embodiments. Therefore, if a modified embodiment includes the constituent elements of the claims of the present disclosure, it shall be considered to fall within the scope of the present disclosure.

What is claimed is:

1. A battery assembly comprising:
a plurality of battery groups each including battery cells;
a receiving case configured to accommodate the plurality of battery groups;
a support portion disposed inside the receiving case with any one of the plurality of battery groups interposed therebetween; and
a busbar portion supported by the support portion inside the receiving case and configured to electrically connect battery cells of the any one of the battery groups or electrically connect between the plurality of battery groups.

2. The battery assembly according to claim 1,
wherein the support portion includes a partition support portion positioned between the any one of the battery groups and another one of the battery groups that is adjacent to the any one of the battery groups, and
wherein the busbar portion includes a first busbar supported by the partition support portion and configured to electrically connect the battery cells of the any one of the battery groups.

3. The battery assembly according to claim 2,
wherein the any one of the battery groups includes a first battery cell and a second battery cell arranged in a stacking direction,
wherein each of the first battery cell and the second battery cell includes a first terminal portion and a second terminal portion protruding for electrical connection, and
wherein the first terminal portion and the second terminal portion of the first battery cell are respectively disposed to overlap with the second terminal portion and the first terminal portion of the second battery cell along the stacking direction.

4. The battery assembly according to claim 3, wherein the first busbar includes:
a first part configured to electrically connect the first terminal portion of the first battery cell and the second terminal portion of the second battery cell; and
a second part extending from the first part toward the partition support portion and coupled to the partition support portion.

5. The battery assembly according to claim 4, wherein the first part and the second part are integrally formed.

6. The battery assembly according to claim 4, wherein the second part is coupled to the partition support portion by a fastening member.

7. The battery assembly according to claim 6, wherein at least a portion of the fastening member is coated with an electrically insulating material.

8. The battery assembly according to claim 4, further comprising an insulating member disposed between the partition support portion and the second part.

9. The battery assembly according to claim 4, wherein, in another one of the battery groups disposed adjacent to the any one of the battery groups with the partition support portion interposed therebetween, the respective second parts of the any one of the battery group and the another one of the battery groups are alternately arranged along the stacking direction on the partition support portion.

10. The battery assembly according to claim 3, wherein the first busbar includes:
extension members respectively extending from the first terminal portion of the first battery cell and the second terminal portion of the second battery cell toward the partition support portion and supported by the partition support portion; and
a connection member supported by the partition support portion and configured to electrically connect the extension members to each other.

11. The battery assembly according to claim 10, wherein the connection member is disposed between the extension members and the partition support portion.

12. The battery assembly according to claim 10, wherein the extension members and the connection member are coupled to the partition support portion by a fastening member.

13. The battery assembly according to claim 12, wherein at least a portion of the fastening member is coated with an electrically insulating material.

14. The battery assembly according to claim 10, further comprising an insulating member disposed on the partition support portion and configured to electrically insulate the first busbar from the partition support portion.

15. The battery assembly according to claim 2, wherein the busbar portion further includes a second busbar supported by the partition support portion and configured to electrically connect between the plurality of battery groups.

16. The battery assembly according to claim 1, wherein, based on a bottom surface of the receiving case, a height of the partition support portion is lower than a height of the battery cell of the any one of the battery groups.

17. The battery assembly according to claim 1, wherein the support portion includes:
a partition support portion positioned between the any one of the battery groups and another one of the battery groups that is adjacent to the any one of the battery groups; and
a side support portion disposed between one side surface of both side surfaces of the receiving case and the plurality of battery groups to face the partition support portion.
